(19) United States
(12) Patent Application Publication
(10) Pub. No.: US 2023/0253572 A1
(43) Pub. Date: Aug. 10, 2023

(54) METHOD FOR BIPOLAR PLATE FABRICATION

(71) Applicant: ESS TECH, INC., Wilsonville, OR (US)

(72) Inventors: Sean Casey, Portland, OR (US); Yang Song, West Linn, OR (US); Thiago Groberg, Tigard, OR (US); Craig Evans, West Linn, OR (US)

(21) Appl. No.: 18/149,910

(22) Filed: Jan. 4, 2023

Related U.S. Application Data
(60) Provisional application No. 63/267,588, filed on Feb. 4, 2022.
(60) Provisional application No. 63/269,515, filed on Mar. 17, 2022.

(51) Int. Cl. H01M 4/88; H01M 4/86

(52) U.S. Cl. CPC H01M 4/8875; H01M 4/8668; H01M 4/8673; H01M 8/188; H01M 2004/8694

(57) ABSTRACT

Systems and methods are provided for a redox flow battery. In one example, the redox flow battery includes a bipolar plate assembly including a bipolar plate formed of a thermoplastic composite material. The thermoplastic composite material of the bipolar plate allows the bipolar plate to be directly bonded to a dielectric frame of the bipolar plate assembly, thereby simplifying a manufacturing process of the bipolar plate assembly.

### CROSS REFERENCE TO RELATED APPLICATIONS

The present application claims priority to U.S. Provisional Application No. 63/267,588 entitled “METHOD FOR BIPOLAR PLATE FABRICATION” filed Feb. 4, 2022 and to U.S. Provisional Application No. 63/269,515 entitled “METHOD FOR BIPOLAR PLATE FABRICATION” filed Mar. 17, 2022. The entire contents of the above identified applications are hereby incorporated by reference for all purposes.

### FIELD

The present description relates generally to a redox flow battery system.

### BACKGROUND AND SUMMARY

Redox flow batteries are suitable for grid scale storage applications due to their capabilities of scaling power and capacity independently, and charging and discharging for thousands of cycles with minimal performance losses. A redox flow battery cell includes negative and positive electrodes that are each connected to a bipolar plate. The bipolar plates may be made of highly conductive materials, such that the electrons may be transported to reaction sites of the negative and positive electrodes, and may further serve as fluid separators for electrolyte flow and distribution.

In one example, a bipolar plate used in conjunction with the negative electrode in a plating electrode assembly may be formed from a graphite composite. The graphite composite may be formed from a thermoset material via a compression molding process. While the thermoset material may be highly conductive, coupling of other components of the electrode assembly to the thermoset material may be plagued with various challenges. For example, the compression molding process may impose size and aspect ratio constraints on the bipolar plate, which may result in dividing the bipolar plate into more than one section, with each section individually attached to a dielectric frame of a bipolar plate assembly. Further, the thermoset material may have a coefficient of thermal expansion (CTE) that is different from a material used to form the dielectric frame. As a result of the CTE difference, the bipolar plate may be attached to the dielectric frame via a rubber flange, adding cost and complexity to a manufacturing process of the bipolar plate assembly. Still further, the thermoset material may be brittle and prone to cracking under strain.

In one embodiment, the issues described above may be addressed by a bipolar plate assembly including a bipolar plate formed of a thermoplastic composite material. The thermoplastic composite material may include a thermoplastic polymer that is also used to form the dielectric frame. As such, the thermoplastic composite bipolar plate may be joined to the dielectric frame by a simple process such as welding or overmolding. A manufacturing process may therefore be simplified to produce a more robust bipolar plate assembly.

In this way the technical effect of increasing a compatibility between a material of the bipolar plate and a material of the dielectric frame is achieved. A manufacturing process of the electrode assembly is simplified due to a CTE that is more compatible with the dielectric frame material, relatively low melting point, increased elasticity, and other material properties of the thermoplastic composite bipolar plate. The process may also preclude dividing the bipolar plate into sections. Further, the bipolar plate can be directly coupled to the dielectric frame, thereby obviating use of an additional flange piece for coupling of the bipolar plate to the dielectric frame. Still further, as assembled, the bipolar plate assembly incorporating the thermoplastic composite bipolar plate forms a robust unit resistant to cracking or breaking.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a battery cell with bipolar plates.

FIG. 2 shows a side view of an example layout for the redox flow battery system of FIG. 1.

FIG. 3A shows an example of an image of a thermoplastic composite bipolar plate welded to a dielectric frame.

FIG. 3B shows a detailed view of a section of the thermoplastic composite bipolar plate of FIG. 3A.

FIG. 4 shows an example of a thermoplastic composite bipolar plate.

FIG. 5A shows a first example of coupling of the thermoplastic bipolar plate to a dielectric frame.

FIG. 5B shows a second example of coupling of the thermoplastic bipolar plate to the dielectric frame.

FIG. 6 shows an exploded view of a power module of the redox flow battery system.

FIG. 7 shows an example of a method for forming a thermoplastic bipolar plate assembly.

FIG. 8 shows a comparison of in-plane resistivity measured for different types of bipolar plates.

FIG. 9 shows a comparison of through-plane resistivity for different types of bipolar plates.

FIG. 10 shows a graph depicting variations in plating thickness at different locations on a thermoplastic bipolar plate.

### DETAILED DESCRIPTION

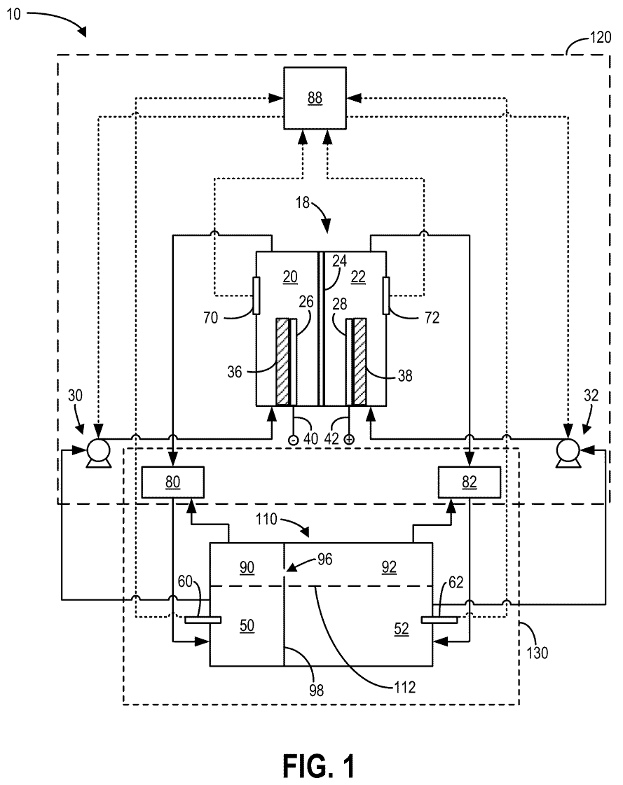

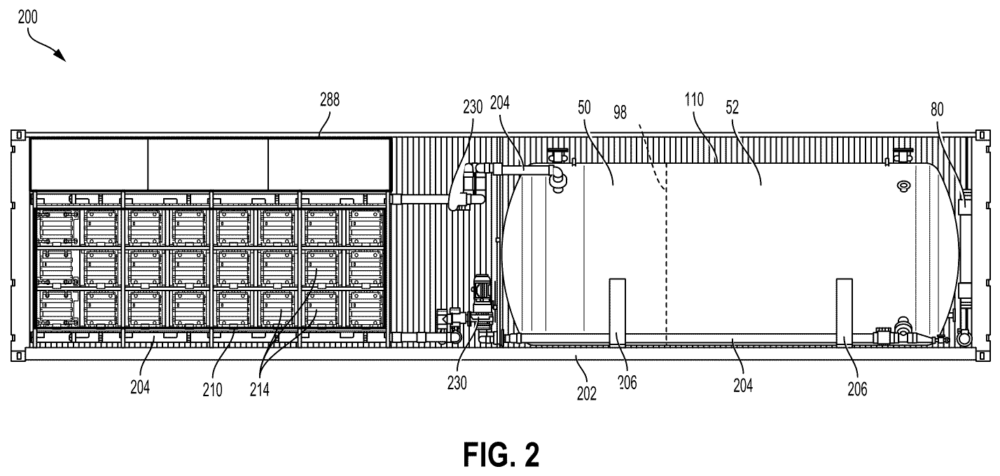

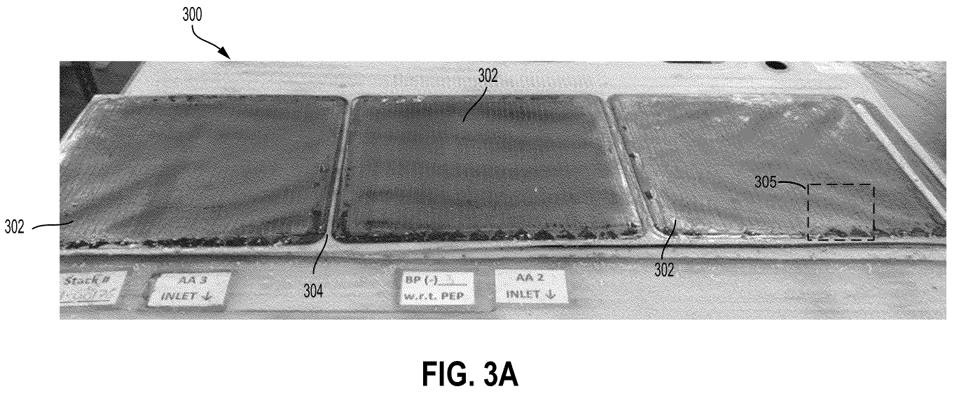

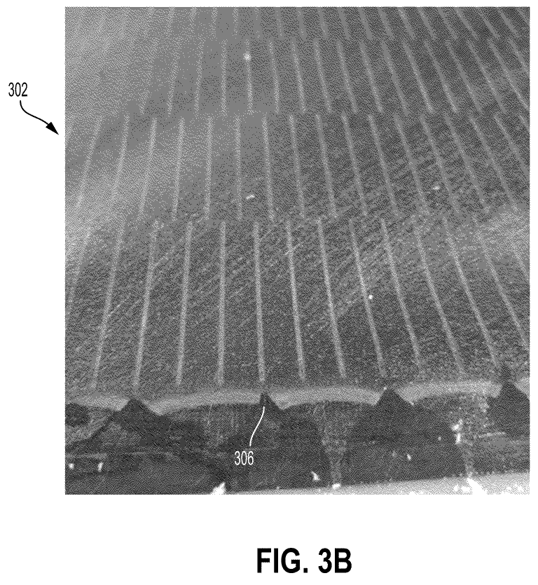

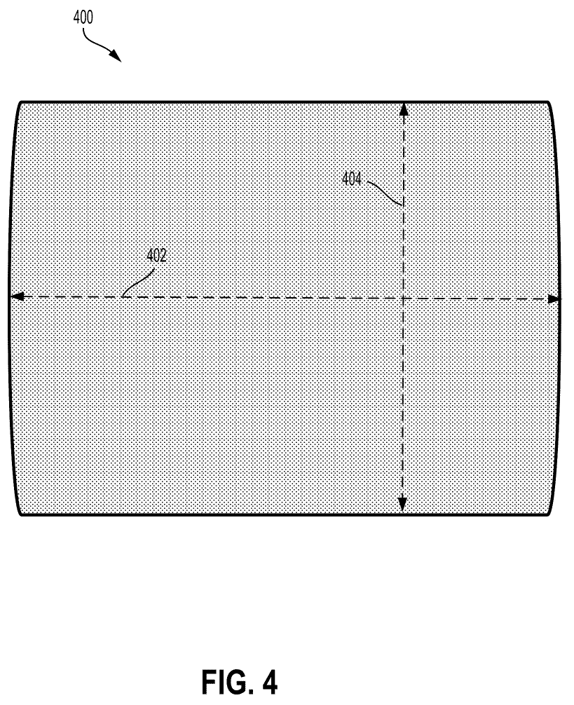

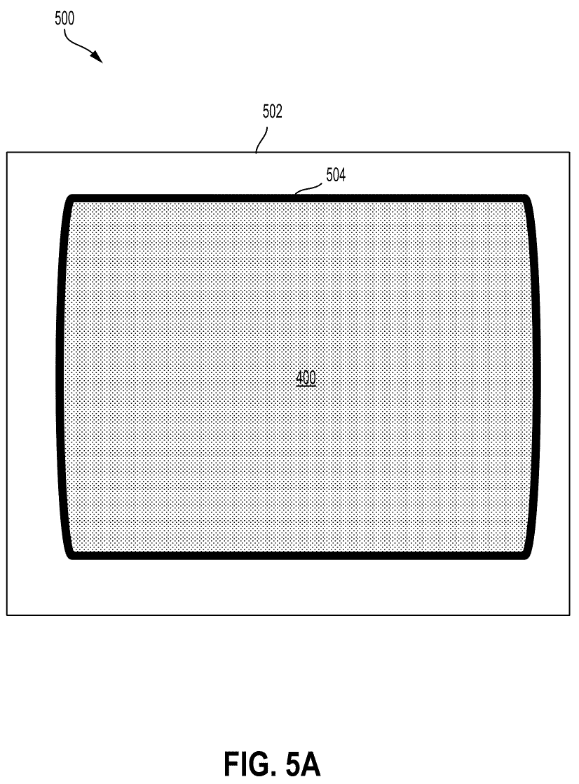

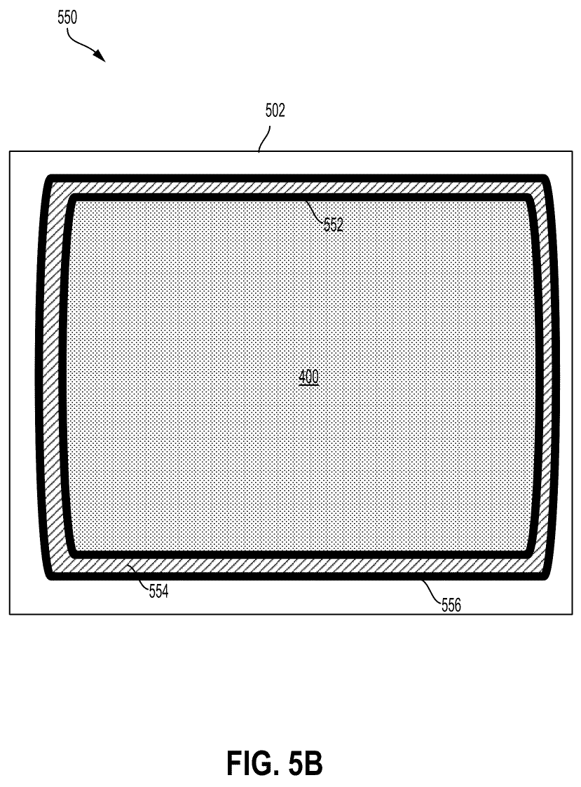

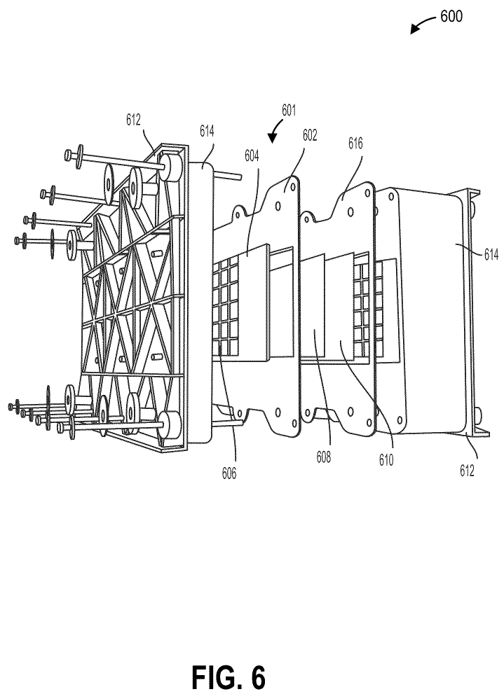

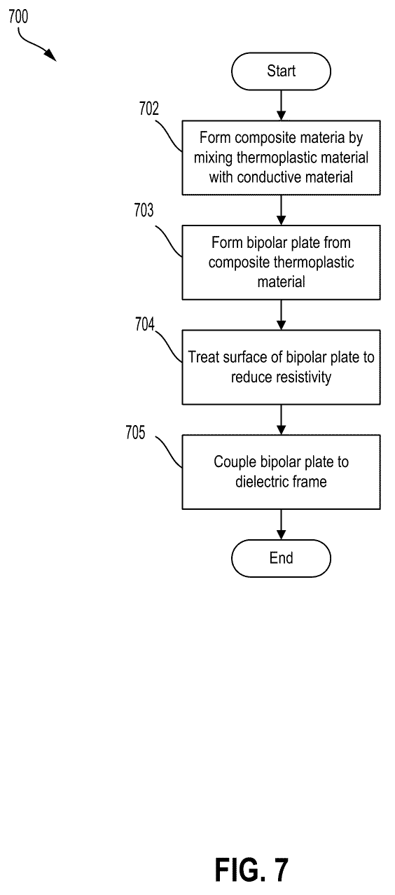

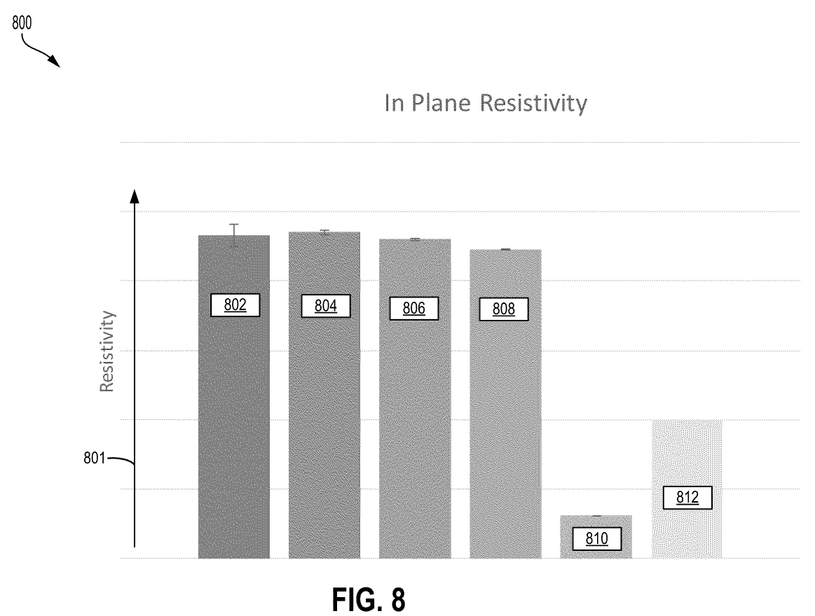

The following description relates to materials and methods for a redox flow battery. In one embodiment, a bipolar plate of the redox flow battery may be formed from a thermoplastic composite. In another embodiment, a method for fabricating the bipolar plate is provided. FIGS. 1-2 schematically show a redox flow battery and a system including more than one redox flow battery, respectively. FIGS. 3A-3B show a first example of a thermoplastic composite bipolar plate welded to a dielectric frame. A second example of a thermoplastic composite bipolar plate is depicted in FIG. 4 and coupling of the thermoplastic composite bipolar plate to the dielectric frame is illustrated in FIGS. 5A-B. The thermoplastic composite bipolar plate and dielectric frame fit into a larger electrode assembly. FIG. 6 shows an exploded diagram of an electrode assembly. FIG. 7 shows an example of a method for making and using the thermoplastic composite bipolar plate. FIGS. 8-10 show experimentally determined properties of the thermoplastic composite bipolar plate and an evaluation of its suitability as a bipolar plate.

Turning first to FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

$${\text{Fe}}^{2 +} + {\text{2e}}^{\text{-}} ↔ {\text{Fe}}^{\text{0}} \text{-0} \text{.44} \text{V} \left(\text{negative} \text{electrode}\right)$$

$${\text{2Fe}}^{2 +} ↔ 2 {\text{Fe}}^{\text{3+}} + 2 {\text{e}}^{\text{-}} + 0.77 \text{V} \left(\text{positive} \text{electrode}\right)$$

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is -0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron’s electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

Referring now to FIG. 2, a side view of an example redox flow battery system layout 200 for the redox flow battery system 10 is shown. Redox flow battery system layout 200 may be housed within a housing 202 that facilitates long-distance transport and delivery of the redox flow battery system 10. In some examples, the housing 202 can include a standard steel freight container or a freight trailer that can be transported via rail, truck or ship. The redox flow battery system layout 200 can include the integrated multi-chambered electrolyte storage tank 110 and one or more rebalancing reactors (e.g., rebalancing reactor 80) positioned at a first side of the housing 202, and a power module 210, and power control system (PCS) 288 at a second side of the housing 202. Auxiliary components such as supports 206, as well as various piping 204, pumps 230, valves (not shown at FIG. 2), and the like may be included within the housing 202 (as further described above with reference to FIG. 1) for stabilizing and fluidly connecting the various components positioned therein. For example, one or more pumps 230 may be utilized to convey electrolyte from the integrated multi-chambered electrolyte storage tank 110 to one or more redox flow battery cell stacks 214 within the power module 210. Furthermore, additional pumps 230 may be utilized to return electrolyte from the power module 210 to the negative electrolyte chamber 50 or the positive electrolyte chamber 52 of the integrated multi-chambered electrolyte storage tank 110.

Power module 210 may include one or more redox flow battery cell stacks 214 electrically connected in parallel and/or in series. Each of the one or more redox flow battery cell stacks 214 may further include a plurality of redox flow battery cells, such as the redox flow battery cell 18 of FIG. 1, connected in parallel and/or series. In this way, power module 210 may be able to supply a range of current and/or voltages to external loads. The PCS 288 includes controller 88 of FIG. 1, as well as other electronics, for controlling and monitoring operation of the redox flow battery system 10. Furthermore, PCS 288 may regulate and monitor voltage supplied to external loads, as well as supplying current and/or voltage from external sources for charging of the power module 210. The PCS 288 may further regulate and control operation of the redox flow battery system 10 during an idle state or idle mode. The redox flow battery system 10 being in an idle state may include when the power module 210 is not in a charge mode or a discharge mode. As an example, the power module 210 may be in the charge mode when an external voltage or current is supplied to one or more redox flow battery cells 18 of the power module 210 resulting in reduction of electrolyte and plating of the reduced electrolyte at the bipolar plate 36 connected to the negative electrode(s) of the one or more redox flow battery cells 18. For the case of an IFB, ferrous ions may be reduced at the plating electrode(s) of one or more redox flow battery cells 18, thereby plating iron thereat during charging of the power module 210. As another example, the power module 210 may be in the discharge mode when voltage or current is supplied from one or more redox flow battery cells 18 of the power module 210 resulting in oxidation of plated metal at the negative electrode resulting in deplating (e.g., loss of metal) and solubilizing of the oxidized metal ions. For the case of an IFB, iron may be oxidized at the plating electrode of one or more redox flow battery cells 18, thereby solubilizing ferrous ions thereat during discharging of the power module 210.

The redox flow battery system layout 200 includes many electrode assemblies, each with at least one bipolar plate assembly coupled to the plating electrode. In a conventional bipolar plate assembly, a bipolar plate of the bipolar plate assembly may be formed of a highly conductive thermoset polymer composite. The thermoset polymer composite may not be welded directly to a dielectric frame of the bipolar plate assembly and instead rely on a rubber flange for attachment. Further, the thermoset polymer composite may be brittle and may crack during fabrication of the bipolar plate assembly. Additionally, the dielectric frame may be formed from a different material than the bipolar plate, such as a thermoplastic material. By alternatively incorporating a bipolar plate that is made of the same or complimentary thermoplastic material, the bipolar plate may be directly welded to or overmolded on the dielectric frame, thereby simplifying manufacturing of the bipolar plate assembly. Additionally, a thermoplastic composite bipolar plate may have increased flexibility and elasticity leading to increased durability of the bipolar plate and fewer issues, such as poor sealing and bonding, cracking, size constraints, etc., during assembly.

In one example, a bipolar plate of a bipolar plate assembly may be formed of a thermoplastic composite. For example, a bipolar plate assembly 300 is depicted in FIG. 3A. The bipolar plate assembly 300 includes a plurality of bipolar plates 302, each of the bipolar plates 302 coupled to a bipolar plate frame 304. Each of the plurality of bipolar plates 302 may be formed of a thermoplastic composite including a thermoplastic polymer mixed with a conductive material, such as a polypropylene/graphite composite. As an example, the polypropylene/graphite may include a polypropylene (PP) base with 60% - 80% graphite by weight. As an alternate example, the polypropylene/graphite may include 40% - 95% graphite by weight. The bipolar plate frame 304, which may be a dielectric frame configured to store and polarize electric charge, may be formed of a thermoplastic polymer, such as PP.

By incorporating at least a portion of the bipolar plate material as the thermoplastic polymer, methods for coupling the bipolar plates 302 to the bipolar plate frame 304 may be broadened, thereby allowing for more simple, direct techniques and well as more robust attachment. For example, in contrast to coupling of bipolar plates formed of a thermoset material to a dielectric frame, the bipolar plates 302 may be directly welded and sealed to the bipolar plate frame 304, as shown in FIG. 3A, due to the common thermoplastic polymer used for both components. By using similar base resins for the components, the components may have similar melting point, allowing the components to physically adhere to one another.

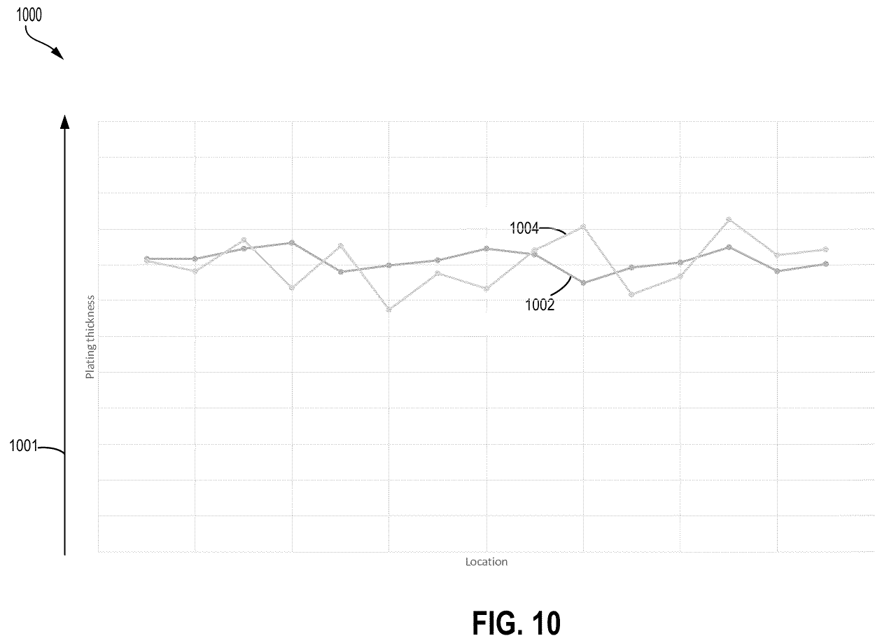

In some examples, and illustrated in FIG. 3A, welding may result in rippling at surfaces of the bipolar plates 302. A more detailed view depicting the warping, particular at inlets 306 of one of the bipolar plates 302 surface, is shown in FIG. 3B. The view shown in FIG. 3B corresponds to a portion of one of bipolar plates 302 outlined by box 305 of FIG. 3A. Rippled bipolar plate surfaces, in some instances, may result in uneven plating on the bipolar plate. Other methods of coupling the bipolar plates 302 to the bipolar plate frame 304, such as injection molding, may reduce or mitigate the rippling, however. As another example, a plasma treatment may be applied to the bipolar plates 302 to enable use of an adhesive to bond the bipolar plate 302 to the bipolar plate frame 304. In spite of the rippling at the bipolar plates 302, the bipolar plate assembly 300 may demonstrate desirable electrochemical performance in a redox battery cell, as shown in FIG. 10 and described further below.

While the bipolar plate assembly 300 of FIG. 3A includes three bipolar plates 302, other examples may include different quantities of bipolar plates coupled to the bipolar plate frame. For example, as shown in FIG. 4, a single bipolar plate 400 may be used in a bipolar plate assembly, thereby allowing the bipolar plate 400 to have a larger width 402 and height 404 than, for example, each of the bipolar plates 302 of FIG. 3A. By incorporating a bipolar plate assembly into a redox flow battery cell with a reduced number of bipolar plates per assembly, fabrication may be simplified, e.g., less coupling of components leading to a decrease in fabrication cycle time, less costly welding equipment may be used, an active bipolar plate surface area may be increased, and adverse effects of attachment processes, such as rippling due to welding, may be reduced.

The bipolar plate 400 may be similarly formed of a thermoplastic polymer (e.g., thermoplastic composite) such as, but not limited, to PP, polyphenylene sulfide (PPS), polyphenylsulfone (PPSU), polyether ether ketone (PEEK), polytetrafluoroethylene (PTFE), or perfluororalkoxy alkane (PFA), mixed with a conductive filler, to form a thermoplastic composite. The thermoplastic composite bipolar plate 400 may be formed by methods known in the art for high volume thermoplastic manufacturing. Such methods may include, but are not limited to: injection molding, extrusion, thermoforming, and blow molding. In one example, the thermoplastic composite bipolar plate 400 may be formed of 40% - 95% by weight of the conductive filler and 5% - 60% by weight of the thermoplastic polymer. As an alternate example, the thermoplastic composite bipolar plate 400 may be formed of 60% - 80% of the conductive filler and 20% - 40% by weight of the thermoplastic polymer. The conductive filler may be a conductive material compatible with the redox flow battery electrolyte such as carbon (such as but not limited to: carbon particles, carbon fiber, carbon black, graphene, and carbon nanotubes), titanium, titanium alloy, stainless steel, or any other conductive metal, element, or alloy, etc. The conductive filler may have a number of different particle shapes including but not limited to: fine grains, filaments, fibers, plates, tubes, as well as other crystal structures. Inclusion of the conductive filler may result in a bipolar plate having a resistivity in the range of 0.01 – 15 Ohm-mm. As a result of incorporation of the thermoplastic composite, the bipolar plate may be stronger and more elastic than a bipolar plate formed from a thermoset material. For example, the thermoplastic bipolar plate may have an elastic modulus in a range of 0.8 GPa – 25 GPa and a yield strength in a range of 15 MPa – 100 MPa.

Similar to fabrication of thermoset composite bipolar plates, manufacturing of the thermoplastic composite bipolar plate may result in a surface that is rich in thermoplastic resin which may lead to poor conductivity at the surface if left untreated. As such, the surface conductivity of the thermoplastic bipolar plate may be increased via known treatments for enhancing conductivity at thermoset composite bipolar plates. For example, a surface treatment may be applied. The bipolar plate surface may be abraded and textured by sanding, knurling, or milling. Additionally, the conductivity of the thermoplastic composite bipolar plate may also be increased by embossing a texture into the surface of the bipolar plate, thereby disrupting a continuity of the surface. Furthermore, properties attributable to the thermoplastic polymer of the bipolar plate may allow heated graphite particles to be impinged on the surface, thereby forming conductive bridges across resin rich surface layers of the bipolar plate. Conductive bridges may also be formed by using graphite fibers of greater length and orienting the fibers outwards along the bipolar plate.

Additionally, carbon particles may be impregnated at the surface of the thermoplastic composite bipolar plate. In one embodiment, the carbon particles may be formed of an ordered carbon material such as graphite. Additionally or alternatively, the carbon particles may be formed of a glassy carbon material. The carbon particles may be roughly 3-dimensional spherical particles having diameters between 10 µm and 100 µm.

The carbon particles may be impregnated at the surface directly following the thermoplastic forming process (e.g., extrusion) while the thermoplastic material is still hot and therefore tacky. Impregnation may include impinging or pressing carbon particles at the surface of the thermoplastic composite bipolar plate. As a result, carbon particles may be primarily located at the surface of the thermoplastic composite bipolar plate. Carbon particles may be distributed substantially evenly across the surface. The surface density (e.g., particles/m²) of carbon particles may be such that each carbon particle may touch at least one other carbon particle, creating a conductive bridge across the surface. Although carbon particles may be primarily located at the surface, a subset of carbon particles may penetrate past the resin rich surface of the bipolar plate during impregnation. The carbon particles penetrating the resin rich surface of the thermoplastic bipolar plate may create a conductive bridge from the resin rich surface to the more conductive composite rich layers underneath.

Once manufactured and treated, the thermoplastic composite bipolar plate may be coupled to a dielectric frame. For example, FIG. 5A shows a bipolar plate assembly 500 including the bipolar plate 400 of FIG. 4 mounted on a bipolar plate frame (e.g., a dielectric frame) 502. The dielectric frame 502 may also be formed of a thermoplastic material or thermoplastic composite including PP, PPS, PPSU, PEEK, PTFE, and PFA. Unlike bipolar plate 400, the thermoplastic composite forming dielectric frame 502 may include a blend of thermoplastic materials and may not include conductive filler. Preferably, the dielectric frame 502 and the bipolar plate 400 are made from the same thermoplastic material or materials with similar CTEs. If the CTEs of the bipolar plate 400 and the dielectric frame 502 differ to an extent that causes warping and a decrease in battery performance, an intermediate material may be used as described below with reference to FIG. 5B.

The bipolar plate 400 may be formed such that width 402 and height 404 correspond to maximum allowable dimensions of bipolar plate 400. In this way, bipolar plate 400 may be a single unit occupying a maximum allowable area inside the dielectric frame 502. By forming the bipolar plate 400 from the thermoplastic material, the bipolar plate may be free of size and aspect ratio constraints imposed on thermoset material-based bipolar plates, resulting from a fabrication method of forming the thermoset material-based bipolar plates. The bipolar plate 400 may therefore have larger dimensions and a wider range of aspect ratios than a bipolar plate formed from the thermoset material. As shown in FIG. 5A, a seal 504 may be formed between the bipolar plate 400 and the dielectric frame 502. The seal 504 may be formed by welding the bipolar plate 400 to the dielectric frame 502, where the thermoplastic materials of the components have a similar melting point. In another example, the bipolar plate 400 and the dielectric frame 502 may both be manufactured via injection molding, and the seal 504 may be formed by an overmolding process. Seal 504 and overmolding may both be examples of direct bonding between bipolar plate 400 and dielectric frame 502, both of which may be enabled by compatible material properties (e.g., CTE and/or melting points) of bipolar plate 400 and dielectric frame 502.

Turning now to FIG. 5B, an alternate embodiment of a bipolar plate assembly 550 is shown, including bipolar plate 400 coupled to the dielectric frame 502 via an intermediate, interfacing material. The bipolar plate assembly 550 may be used when the CTE of the bipolar plate 400 and the dielectric frame 502 are different. To remediate the difference in CTEs, the bipolar plate 400 may be attached by a first seal 552 to a first edge of an intermediate flange 554. Intermediate flange 554 may be formed of a flexible thermoplastic material having a CTE between that of the bipolar plate 400 and the dielectric frame 502, such as a thermoplastic rubber. The first seal 552 may be formed by thermal welding similar to the seal 504 of FIG. 5A. A second edge of flange 554, opposite of the first edge, may be attached to the dielectric frame 502 by a second seal 556. The second seal 556 may also be formed by thermal welding. Alternatively, laser welding may be used instead of thermal welding. In this way, the bipolar plate 400 may be attached to the dielectric frame 502 via intermediate flange 554.

FIG. 6 shows an exploded view of an example of an electrode assembly 600. Components of the electrode assembly 600 may be included in a redox flow battery cell, such as the redox flow battery cell 18 of FIG. 1. Multiple electrode assemblies, each electrode assembly similarly configured to the electrode assembly 600 of FIG. 6, may form redox flow battery cell stacks, such as the redox flow battery cell stacks 214 of FIG. 2.

The electrode assembly 600 may include one or more bipolar plate assemblies 601, each bipolar plate assembly formed of a dielectric frame 602 surrounding at least one thermoplastic composite bipolar plate 604. Further, a negative electrode spacer 606 may be coupled to the thermoplastic composite bipolar plate 604. In one example, the negative electrode spacer 606 may also be a thermoplastic polymer. Thus, the thermoplastic bipolar plate and negative electrode spacer may have similar melting points and may adjoined by welding, simplifying construction of the electrode assembly 600. A positive electrode 608 may be coupled to the composite bipolar plate 604 on a side opposite of the negative electrode spacer 606. In one example, the positive electrode 608 may be formed of felt, such as a carbon felt. In other examples, the positive electrode may also be any conductive material with a high surface area per unit volume that is also compatible with an electrolyte of the redox flow battery. Furthermore, the positive electrode material may be selected based on electrochemical properties that are compatible with an electrochemistry of the redox flow battery. For example, the positive electrode may alternatively be a carbon based paper, e.g., a gas diffusion layer (GDL) or a reticulated carbon foam. A heat-driven welding process may also be used to attach the positive electrode 608 to the thermoplastic composite bipolar plate 604, resulting in high conduction between the two components, thus enhancing performance of the redox flow battery. As another example, the positive electrode 608 and the thermoplastic composite bipolar plate 604 may be coupled using laser welding. Furthermore, coupling of the negative electrode spacer, the bipolar plate 604, and the positive electrode 608, as described above, allows the electrode assembly 600 to be manufactured as a single unit, thereby simplifying an assembly process of the electrode assembly 600.

A membrane 610 surrounded by a membrane frame 616 may be positioned adjacent to the positive electrode 608, opposite the bipolar plate 604. Pressure plates 612 and picture frames 614 may be arranged at either end of the electrode assembly 600. Together, pressure plates 612 and picture frames 614 may secure the components of the electrode assembly 600 to one another and seal fluids within an interior of the electrode assembly 600.

FIG. 7 shows a method 700, for fabricating and incorporating a thermoplastic composite bipolar plate in a bipolar plate assembly. At 702, method 700 includes forming the composite material by mixing a thermoplastic material with a conductive material. As described above, with reference to FIG. 4, the materials forming the thermoplastic composite may be selected from a number of different thermoplastic polymers and carbon-based conductive materials. A ratio by weight of conductive material to polymer material may range from 2:3 to 1:4. Once composited, at 703, method 700 includes forming the material into at least one bipolar plate with target dimensions according to dimensions of an opening in a dielectric frame configured to receive the bipolar plate. Any known method for high volume manufacturing process of thermoplastic material, as described with reference to FIG. 4 may be used at 703. At 704, method 700 includes treating a surface of the thermoplastic composite material of the bipolar plate to reduce resistivity (e.g., increase conductivity), as described above. For example, surface treatment may include abrading, texturing, etc. Finally, method 700 includes attaching the thermoplastic composite bipolar plate to the dielectric frame at 705. As described above with reference to FIGS. 5A-B, the thermoplastic composite bipolar plate may be welded or overmolded to the dielectric frame or may be welded to an intermediary flange positioned between the bipolar plate and the dielectric flange and configured to couple the bipolar plate to the dielectric flange.

Resistivity of a bipolar plate may be measured as an indicator of a performance of the bipolar plate material. As electrons are conducted from an electrode to a surface of the bipolar plate to carry out electrochemical reactions driving operation of a redox flow battery, low resistivity may be a desired property for the bipolar plate. In this way, the electrochemical reactions, including iron plating, may occur efficiently thereby improving an efficiency of the redox flow battery. A graph 800 is depicted in FIG. 8, depicting a measured in-plane resistivity of bipolar plates made from different materials, including thermoplastic polypropylene (PP) composites and from thermoset composites. Resistivity is plotted along the y-axis according to a bipolar plate type and surface treatment received. For example, a first column 802 represents a resistivity of a PP bipolar plate without surface treatment, the resistivity measured along a direction in which the bipolar plate is extruded, a second column 804 represents a resistivity of a PP bipolar plate, similarly measured along the direction of extrusion, that is machine sanded, a third column 806 represents a resistivity of a PP bipolar plate that is not sanded, the resistivity measured along a direction transverse (e.g., perpendicular) to the extrusion direction, a fourth column 808 represents a resistivity of a PP bipolar plate that is sanded and measured along the transverse direction, a fifth column 810 represents a resistivity of a compression molded thermoset composite bipolar plate receiving orbital scuffing, and a sixth column 812 represents a resistivity for the thermoset composite bipolar plate material based on manufacturer’s specifications.

The results shown in graph 800 indicate that even after receiving a surface treatment, the in-plane resistivities of the PP bipolar plates are still higher (e.g., at least 2 times higher) than the in-plane resistivity of the PP bipolar plate without surface treatment (e.g., the sixth column 812). The results shown in graph 800 also indicate that extrusion direction has little effect on in-plane resistivity of the extruded material and surface treatment has an equally small effect on lowering resistivity in both directions. The resistivities of the PP bipolar plates are, however, higher than the resistivity of the thermoset composite bipolar plate.

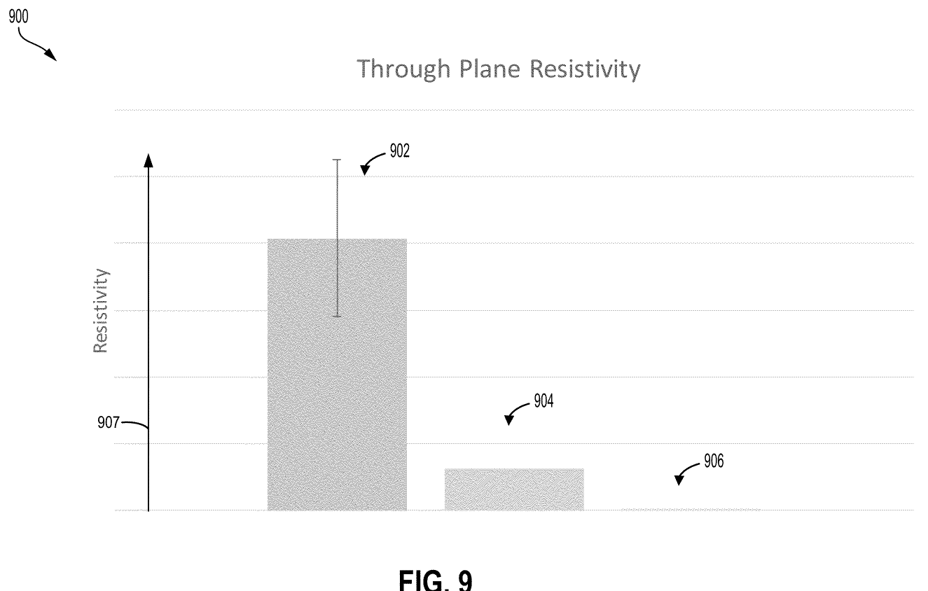

A through-plane resistivity of compression molded thermoset composite bipolar plates and of an extruded PP bipolar plate is shown in a graph 900 in FIG. 9. Similar to graph 800 of FIG. 9, resistivity is plotted along the y-axis and sample types are presented as columns along the x-axis. The sample types including an extrusion molded PP bipolar plate (shown a first column 902), a compression molded thermoset composite bipolar plate (shown in a second column 904), and the manufacturer’s resistivity specification for the thermoset composite bipolar plate (shown in a third column 906). Similar to the in-plane resistivity, the through-plane resistivity of the PP bipolar plate is higher than the through-plane resistivity of the thermoset composite bipolar plate.

The higher resistivity of the PP bipolar plates relative to the thermoset composite bipolar plates may indicate that the PP bipolar plate may correspond to lower performance of a redox flow battery. However, the PP bipolar plate experimentally demonstrates plating thickness and plating quality satisfying desired thickness and quality in spite of the higher resistivity. Bipolar plate performance may be measured by a yield, e.g., plating thickness, and uniformity of a metal plating formed on the bipolar plate during a charging cycle of a redox flow battery system. For example, in an iron flow battery, Fe⁰ is plated at the bipolar plate coupled to the negative electrode when the redox flow battery operates in a charging mode.

A plating thickness and uniformity of a PP bipolar plate arranged in a test redox flow battery cell, after operation of the cell in a charging mode, is shown in a graph 1000 in FIG. 10. The graph 1000 shows the measured plating thickness on the PP bipolar plate at different locations across the PP bipolar plate after charging the test redox flow battery cell to 1.5 MC. The locations are positioned along electrolyte inlets of the PP bipolar plate, as shown by a first plot 1002, and along electrolyte outlets of the PP bipolar plate, as shown by a second plot 1004. A maximum difference between the thicknesses of the first plot 1002 and the thicknesses of the second plot 1004 is about 0.05 mm. Variations in plating thickness along each of the electrolyte inlets and the electrolyte outlets, as well as across the entire width of the PP bipolar plate, does not vary by more than 10%.

In this way, manufacturing of a bipolar plate assembly for a redox flow battery may be simplified without adversely affecting a performance of the redox flow battery. The bipolar plate assembly may include a bipolar plate formed from a thermoplastic composite material. The thermoplastic composite material may have properties, such as a melting point and a CTE, that are compatible with properties of a bipolar plate frame, e.g., dielectric frame, of the bipolar plate assembly. The bipolar plate may be directly welded to the bipolar plate frame, thereby precluding use of additional materials and mechanisms for coupling and bonding the bipolar plate to the bipolar plate frame. Further, the thermoplastic composite bipolar plate may have desirable material characteristics such as greater strength and flexibility than conventional thermoset materials for bipolar plates, resulting in a more robust bipolar plate assembly. Although the thermoplastic composite bipolar plates may demonstrate higher resistivity than bipolar plates formed from the thermoset materials, implementation of the thermoplastic composite bipolar plates may exhibit at least equivalent redox flow battery performance.

The disclosure also provides support for a redox flow battery, comprising: a bipolar plate assembly including a bipolar plate formed of a thermoplastic composite material. In a first example of the system, the thermoplastic composite material is formed of a thermoplastic polymer and a conductive filler and wherein the thermoplastic polymer includes one or more of polypropylene (PP), polyphenylene sulfide (PPS), polyphenylsulfone (PPSU), polyether ether ketone (PEEK), polytetrafluoroethylene (PTFE), and perfluororalkoxy alkane (PFA). In a second example of the system, optionally including the first example, the conductive filler is one or more of graphite, carbon fiber, carbon black, carbon nanotubes, graphene, titanium, a titanium alloy, and a conductive metal. In a third example of the system, optionally including one or both of the first and second examples, the thermoplastic composite material is formed of 5%-60% of the thermoplastic polymer and 40%-95% of the conductive filler. In a fourth example of the system, optionally including one or more or each of the first through third examples, the bipolar plate is formed by one of injection molding, extrusion, thermoforming, and blow molding. In a fifth example of the system, optionally including one or more or each of the first through fourth examples, the bipolar plate is coupled to a dielectric frame by one or more of thermal welding, laser welding, overmolding, adhesive, and an intermediate flange. In a sixth example of the system, optionally including one or more or each of the first through fifth examples, the bipolar plate is divided into more than one section, each section coupled to the dielectric frame. In a seventh example of the system, optionally including one or more or each of the first through sixth examples, the bipolar plate is coupled to the dielectric frame as a single unit with maximum allowable dimensions determined based on dimensions of the dielectric frame.

The disclosure also provides support for a method for forming a bipolar plate assembly, comprising: forming a thermoplastic composite material, forming a bipolar plate from the thermoplastic composite material, treating a surface of the bipolar plate, and coupling the bipolar plate to a dielectric frame. In a first example of the method, forming the thermoplastic composite material includes forming a mixture of a thermoplastic polymer and a conductive filler. In a second example of the method, optionally including the first example, forming the bipolar plate from the thermoplastic composite material includes forming the bipolar plate by a high volume manufacturing process. In a third example of the method, optionally including one or both of the first and second examples, forming the bipolar plate from the thermoplastic composite material includes forming conductive bridges from particles of a conductive filler of the thermoplastic composite material, the conductive bridges formed along surfaces of the bipolar plate. In a fourth example of the method, optionally including one or more or each of the first through third examples, treating the surface of the bipolar plate includes abrading and/or texturing to decrease a resistivity of the thermoplastic composite material and/or impregnating the surface with carbon particles having diameters between 10 µm and 100 µm, wherein the abrading and/or texturing includes one or more of sanding, knurling, milling, and embossing. In a fifth example of the method, optionally including one or more or each of the first through fourth examples, coupling the bipolar plate includes one of welding the bipolar plate directly to the dielectric frame and welding the dielectric frame to an intermediate flange, the intermediate flange welded to the dielectric frame, and wherein the welding is one of thermal welding or laser welding.

The disclosure also provides support for a bipolar plate assembly for a redox flow battery, comprising: a dielectric frame formed of a first thermoplastic composite, and a bipolar plate coupled to the dielectric frame, the bipolar plate formed of a second thermoplastic composite, and wherein the first thermoplastic composite and the second thermoplastic composite have compatible material properties enabling direct bonding of the bipolar plate to the dielectric frame. In a first example of the system, the first thermoplastic composite and the second thermoplastic composite are formed from a common thermoplastic polymer. In a second example of the system, optionally including the first example, the first thermoplastic composite and the second thermoplastic composite have a similar melting point and coefficient of thermal expansion. In a third example of the system, optionally including one or both of the first and second examples, a negative electrode spacer is directly welded to a first side of the bipolar plate. In a fourth example of the system, optionally including one or more or each of the first through third examples, a positive electrode is coupled to a second side of the bipolar plate, opposite the first side, by melting a material of the positive electrode to the second side of the bipolar plate. In a fifth example of the system, optionally including one or more or each of the first through fourth examples, the negative electrode spacer, the positive electrode and the bipolar plate assembly form an electrode assembly.

FIGS. 4-6 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 4-6 are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A redox flow battery, comprising:
a bipolar plate assembly including a bipolar plate formed of a thermoplastic composite material.

2. The redox flow battery of claim 1, wherein the thermoplastic composite material is formed of a thermoplastic polymer and a conductive filler and wherein the thermoplastic polymer includes one or more of polypropylene (PP), polyphenylene sulfide (PPS), polyphenylsulfone (PPSU), polyether ether ketone (PEEK), polytetrafluoroethylene (PTFE), and perfluororalkoxy alkane (PFA).

3. The redox flow battery of claim 2, wherein the conductive filler is one or more of graphite, carbon fiber, carbon black, carbon nanotubes, graphene, titanium, a titanium alloy, and a conductive metal.

4. The redox flow battery of claim 3, wherein the thermoplastic composite material is formed of 5%-60% of the thermoplastic polymer and 40%-95% of the conductive filler.

5. The redox flow battery of claim 1, wherein the bipolar plate is formed by one of injection molding, extrusion, thermoforming, and blow molding.

6. The redox flow battery of claim 1, wherein the bipolar plate is coupled to a dielectric frame by one or more of thermal welding, laser welding, overmolding, adhesive, and an intermediate flange.

7. The redox flow battery of claim 6, wherein the bipolar plate is divided into more than one section, each section coupled to the dielectric frame.

8. The redox flow battery of claim 6, wherein the bipolar plate is coupled to the dielectric frame as a single unit with maximum allowable dimensions determined based on dimensions of the dielectric frame.

9. A method for forming a bipolar plate assembly, comprising:
forming a thermoplastic composite material;
forming a bipolar plate from the thermoplastic composite material;
treating a surface of the bipolar plate; and
coupling the bipolar plate to a dielectric frame.

10. The method of claim 9, wherein forming the thermoplastic composite material includes forming a mixture of a thermoplastic polymer and a conductive filler.

11. The method of claim 9, wherein forming the bipolar plate from the thermoplastic composite material includes forming the bipolar plate by a high volume manufacturing process.

12. The method of claim 9, wherein forming the bipolar plate from the thermoplastic composite material includes forming conductive bridges from particles of a conductive filler of the thermoplastic composite material, the conductive bridges formed along surfaces of the bipolar plate.

13. The method of claim 9, wherein treating the surface of the bipolar plate includes abrading and/or texturing to decrease a resistivity of the thermoplastic composite material and/or impregnating the surface with carbon particles having diameters between 10 µm and 100 µm, wherein the abrading and/or texturing includes one or more of sanding, knurling, milling, and embossing.

14. The method of claim 9, wherein coupling the bipolar plate includes one of welding the bipolar plate directly to the dielectric frame and welding the dielectric frame to an intermediate flange, the intermediate flange welded to the dielectric frame, and wherein the welding is one of thermal welding or laser welding.

15. A bipolar plate assembly for a redox flow battery, comprising:
a dielectric frame formed of a first thermoplastic composite; and
a bipolar plate coupled to the dielectric frame, the bipolar plate formed of a second thermoplastic composite, and wherein the first thermoplastic composite and the second thermoplastic composite have compatible material properties enabling direct bonding of the bipolar plate to the dielectric frame.

16. The bipolar plate assembly of claim 15, wherein the first thermoplastic composite and the second thermoplastic composite are formed from a common thermoplastic polymer.

17. The bipolar plate assembly of claim 15, wherein the first thermoplastic composite and the second thermoplastic composite have a similar melting point and coefficient of thermal expansion.

18. The bipolar plate assembly of claim 15, wherein a negative electrode spacer is directly welded to a first side of the bipolar plate.

19. The bipolar plate assembly of claim 18, wherein a positive electrode is coupled to a second side of the bipolar plate, opposite the first side, by melting a material of the positive electrode to the second side of the bipolar plate.

20. The bipolar plate assembly of claim 19, wherein the negative electrode spacer, the positive electrode and the bipolar plate assembly form an electrode assembly.
